(19) United States
(12) Patent Application Publication
(10) Pub. No.: US 2025/0150855 A1
(43) Pub. Date: May 8, 2025

(54) ADDITIONAL CONDITION INDICATION BASED ON MODEL MONITORING

(71) Applicant: QUALCOMM Incorporated, San Diego, CA (US)

(72) Inventors: Jay Kumar SUNDARARAJAN, San Diego, CA (US); Taesang YOO, San Diego, CA (US)

(21) Appl. No.: 18/930,689

(22) Filed: Oct. 29, 2024

Related U.S. Application Data
(60) Provisional application No. 63/596,162, filed on Nov. 3, 2023.

(51) Int. Cl. H04W 24/02; H04L 41/16

(52) U.S. Cl. CPC H04W 24/02; H04L 41/16

(57) ABSTRACT

Methods, systems, and devices for wireless communications are described. A first wireless device may be configured to communicate signaling with a second wireless device, an additional wireless device, or both, and perform, based on the signaling, one or more inferences using a machine learning model. The first wireless device may transmit, to the second wireless device, an indication that the machine learning model was applicable for performing the one or more inferences, and receive, from the second wireless device, control signaling indicating that the machine learning model is applicable for communications that are associated with a first set of conditions associated with the communication of the signaling, where the control signaling indicates a model identifier (ID) associated with the machine learning model, that the first set of conditions is associated with the machine learning model, or both.

### CROSS REFERENCE

The present Application for Patent claims priority to U.S. Provisional Patent Application No. 63/596,162 by SUNDARARAJAN et al., entitled “ADDITIONAL CONDITION INDICATION BASED ON MODEL MONITORING” and filed Nov. 3, 2023, which is assigned to the assignee hereof and incorporated by reference herein.

### FIELD OF TECHNOLOGY

The following relates to wireless communications, including techniques for additional condition indication based on model monitoring.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless devices (e.g., UEs) may be configured to utilize machine learning models (e.g., machine learning algorithms, neural networks) to infer or predict various characteristics for wireless communications, such as channel quality metrics, beam predictions, UE position, and the like.

### SUMMARY

Machine learning models used within a wireless communications system may be generated or trained in a variety of ways. In some cases, machine learning models may be trained to make specific inferences for a specific training dataset or test dataset. However, the model may additionally or alternatively be used for other circumstances or conditions that were not known at the time of training (e.g., for conditions that are out-of-distribution with respect to the training dataset or test dataset). As such, the model may be underutilized, which may cause the network to unnecessarily train additional models to make inferences or predictions in the same circumstances or conditions that may be covered by the previously trained model.

The described techniques relate to improved methods, systems, devices, and apparatuses that support techniques for identifying, defining, and updating machine learning models that are used to perform various inferences or predictions within a wireless communications system. That is, aspects of the present disclosure are directed to techniques for (1) identifying and defining machine learning models that are to be used for inferences or predictions for specific sets of conditions within a wireless network, and (2) updating machine learning models to apply the machine learning models to new/additional sets of conditions. For example, a user equipment (UE) may test out different machine learning models for making inferences or predictions when communicating with a network entity. In this example, the UE, the network entity, or both may determine that the model was useful or accurate in making the inferences or predictions for a given set of conditions, and may therefore define a model identifier (ID) for the machine learning model so that the model can be referenced and used for making inferences or predictions for that set of conditions in the future. Continuing with the same example, while using the machine learning model to make inferences or predictions for the set of conditions, the wireless devices (e.g., UEs, network entities) may determine that the machine learning model is also useful for making inferences or predictions for additional conditions. In such cases, the wireless devices may exchange signaling with one another to update metadata associated with the machine learning model so that the model can be used in cases for the additional conditions, thereby expanding the use of the model to other conditions or circumstances.

A method by a first wireless device is described. The method may include communicating signaling with a second wireless device, an additional wireless device, or both, performing, based on the communication of the signaling, one or more inferences using a machine learning model, transmitting, to the second wireless device, an indication that the machine learning model was applicable for performing the one or more inferences, and receiving, from the second wireless device, control signaling indicating that the machine learning model is applicable for communications that are associated with a first set of conditions associated with the communication of the signaling, where the control signaling indicates a model ID associated with the machine learning model, an indication that the first set of conditions is associated with the machine learning model, or both.

A first wireless device is described. The first wireless device may include one or more memories storing processor executable code, and one or more processors coupled with the one or more memories. The one or more processors may individually or collectively operable to execute the code to cause the first wireless device to communicating signal with a second wireless device, an additional wireless device, or both, perform, based on the communication of the signaling, one or more inferences using a machine learning model, transmit, to the second wireless device, an indication that the machine learning model was applicable for performing the one or more inferences, and receive, from the second wireless device, control signaling indicating that the machine learning model is applicable for communications that are associated with a first set of conditions associated with the communication of the signaling, where the control signaling indicates a model ID associated with the machine learning model, an indication that the first set of conditions is associated with the machine learning model, or both.

Another first wireless device is described. The first wireless device may include means for communicating signaling with a second wireless device, an additional wireless device, or both, means for performing, based on the communication of the signaling, one or more inferences using a machine learning model, means for transmitting, to the second wireless device, an indication that the machine learning model was applicable for performing the one or more inferences, and means for receiving, from the second wireless device, control signaling indicating that the machine learning model is applicable for communications that are associated with a first set of conditions associated with the communication of the signaling, where the control signaling indicates a model ID associated with the machine learning model, an indication that the first set of conditions is associated with the machine learning model, or both.

A non-transitory computer-readable medium storing code is described. The code may include instructions executable by a processor to communicating signal with a second wireless device, an additional wireless device, or both, perform, based on the communication of the signaling, one or more inferences using a machine learning model, transmit, to the second wireless device, an indication that the machine learning model was applicable for performing the one or more inferences, and receive, from the second wireless device, control signaling indicating that the machine learning model is applicable for communications that are associated with a first set of conditions associated with the communication of the signaling, where the control signaling indicates a model ID associated with the machine learning model, an indication that the first set of conditions is associated with the machine learning model, or both.

Some examples of the method, first wireless devices, and non-transitory computer-readable medium described herein may further include operations, features, means, or instructions for storing a data object that associates the machine learning model with the model ID, the first set of conditions, or both, based on receiving the control signaling, receiving, from the second wireless device, additional control signaling indicating the model ID, the first set of conditions, or both, and performing one or more additional inferences using the machine learning model based on storing the data object and receiving the additional control signaling.

Some examples of the method, first wireless devices, and non-transitory computer-readable medium described herein may further include operations, features, means, or instructions for storing a data object that associates the machine learning model with the model ID, the first set of conditions, or both, based on receiving the control signaling, identifying that the second wireless device may be to communicate in accordance with the first set of conditions, and performing one or more additional inferences using the machine learning model based on storing the data object and identifying that the second wireless device may be communicating in accordance with the first set of conditions.

Some examples of the method, first wireless devices, and non-transitory computer-readable medium described herein may further include operations, features, means, or instructions for transmitting, to the second wireless device, capability signaling indicating a second set of conditions used by the first wireless device to communicate the signaling, where the one or more inferences may be associated with the second set of conditions.

In some examples of the method, first wireless devices, and non-transitory computer-readable medium described herein, the control signaling indicates that the machine learning model may be applicable for communications associated with the second set of conditions.

In some examples of the method, first wireless devices, and non-transitory computer-readable medium described herein, the second set of conditions include a quantity of communication layers supported at the first wireless device, a quantity of antennas at the first wireless device, or both.

Some examples of the method, first wireless devices, and non-transitory computer-readable medium described herein may further include operations, features, means, or instructions for communicating additional signaling with the second wireless device, the additional wireless device, or both, in accordance with a set of additional conditions associated with the second wireless device, performing, based on communicating the additional signaling in accordance with the set of additional conditions, one or more additional inferences using the machine learning model, and transmitting, to the second wireless device, a control message indicating that the machine learning model was applicable for performing the one or more additional inferences associated with the set of additional conditions.

Some examples of the method, first wireless devices, and non-transitory computer-readable medium described herein may further include operations, features, means, or instructions for receiving, from the second wireless device, additional control signaling indicating that the machine learning model may be associated with the set of additional conditions and updating a data object associated with the machine learning model to include information associated with an association between the machine learning model and the set of additional conditions based on receiving the additional control signaling.

In some examples of the method, first wireless devices, and non-transitory computer-readable medium described herein, the set of additional conditions include a speed of the first wireless device, a signal quality metric of wireless communications received by the first wireless device, network-based additional conditions, or any combination thereof.

In some examples of the method, first wireless devices, and non-transitory computer-readable medium described herein, the first set of conditions include one or more network settings, a radio resource control (RRC) configuration, or both.

In some examples of the method, first wireless devices, and non-transitory computer-readable medium described herein, the one or more inferences include an inference associated with channel state feedback, an inference associated with one or more beams usable by the first wireless device, an inference associated with a geographical position of the first wireless device, or any combination thereof.

In some examples of the method, first wireless devices, and non-transitory computer-readable medium described herein, the machine learning model includes a neural network model.

In some examples of the method, first wireless devices, and non-transitory computer-readable medium described herein, the first wireless device includes a UE and the second wireless device includes a network entity and the first wireless device includes the network entity and the second wireless device includes the UE.

Some examples of the method, first wireless devices, and non-transitory computer-readable medium described herein may further include operations, features, means, or instructions for monitoring a performance of the machine learning model based on performing the one or more inferences and determining that the machine learning model may be applicable for performing the one or more inferences based on monitoring the performance of the machine learning model.

A method by a first wireless device is described. The method may include communicating signaling with a second wireless device, an additional wireless device, or both, performing, based on the communication of the signaling, one or more inferences using a functionality, transmitting, to the second wireless device, an indication that the functionality was applicable for performing the one or more inferences, and receiving, from the second wireless device, control signaling indicating that the functionality is applicable for communications that are associated with a first set of conditions associated with the communication of the signaling, where the control signaling indicates a functionality ID associated with the functionality, an indication that the first set of conditions is associated with the functionality, or both.

A first wireless device is described. The first wireless device may include one or more memories storing processor executable code, and one or more processors coupled with the one or more memories. The one or more processors may individually or collectively operable to execute the code to cause the first wireless device to communicating signal with a second wireless device, an additional wireless device, or both, perform, based on the communication of the signaling, one or more inferences using a functionality, transmit, to the second wireless device, an indication that the functionality was applicable for performing the one or more inferences, and receive, from the second wireless device, control signaling indicating that the functionality is applicable for communications that are associated with a first set of conditions associated with the communication of the signaling, where the control signaling indicates a functionality ID associated with the functionality, an indication that the first set of conditions is associated with the functionality, or both.

Another first wireless device is described. The first wireless device may include means for communicating signaling with a second wireless device, an additional wireless device, or both, means for performing, based on the communication of the signaling, one or more inferences using a functionality, means for transmitting, to the second wireless device, an indication that the functionality was applicable for performing the one or more inferences, and means for receiving, from the second wireless device, control signaling indicating that the functionality is applicable for communications that are associated with a first set of conditions associated with the communication of the signaling, where the control signaling indicates a functionality ID associated with the functionality, an indication that the first set of conditions is associated with the functionality, or both.

A non-transitory computer-readable medium storing code is described. The code may include instructions executable by a processor to communicating signal with a second wireless device, an additional wireless device, or both, perform, based on the communication of the signaling, one or more inferences using a functionality, transmit, to the second wireless device, an indication that the functionality was applicable for performing the one or more inferences, and receive, from the second wireless device, control signaling indicating that the functionality is applicable for communications that are associated with a first set of conditions associated with the communication of the signaling, where the control signaling indicates a functionality ID associated with the functionality, an indication that the first set of conditions is associated with the functionality, or both.

Some examples of the method, first wireless devices, and non-transitory computer-readable medium described herein may further include operations, features, means, or instructions for storing a data object that associates the functionality with the functionality identifier, the first set of conditions, or both, based on receiving the control signaling, receiving, from the second wireless device, additional control signaling indicating the functionality identifier, the first set of conditions, or both, and performing one or more additional inferences using the functionality based on storing the data object and receiving the additional control signaling.

Some examples of the method, first wireless devices, and non-transitory computer-readable medium described herein may further include operations, features, means, or instructions for storing a data object that associates the functionality with the functionality identifier, the first set of conditions, or both, based on receiving the control signaling, identifying that the second wireless device may be to communicate in accordance with the first set of conditions, and performing one or more additional inferences using the functionality based on storing the data object and identifying that the second wireless device may be communicating in accordance with the first set of conditions.

Some examples of the method, first wireless devices, and non-transitory computer-readable medium described herein may further include operations, features, means, or instructions for transmitting, to the second wireless device, capability signaling indicating a second set of conditions used by the first wireless device to communicate the signaling, where the one or more inferences may be associated with the second set of conditions.

In some examples of the method, first wireless devices, and non-transitory computer-readable medium described herein, the control signaling indicates that the functionality may be applicable for communications associated with the second set of conditions.

In some examples of the method, first wireless devices, and non-transitory computer-readable medium described herein, the second set of conditions include a quantity of communication layers supported at the first wireless device, a quantity of antennas at the first wireless device, or both.

Some examples of the method, first wireless devices, and non-transitory computer-readable medium described herein may further include operations, features, means, or instructions for communicating additional signaling with the second wireless device, the additional wireless device, or both, in accordance with a set of additional conditions associated with the second wireless device, performing, based on communicating the additional signaling in accordance with the set of additional conditions, one or more additional inferences using the functionality, and transmitting, to the second wireless device, a control message indicating that the functionality was applicable for performing the one or more additional inferences associated with the set of additional conditions.

Some examples of the method, first wireless devices, and non-transitory computer-readable medium described herein may further include operations, features, means, or instructions for receiving, from the second wireless device, additional control signaling indicating that the functionality may be associated with the set of additional conditions and updating a data object associated with the functionality to include information associated with an association between the functionality and the set of additional conditions based on receiving the additional control signaling.

In some examples of the method, first wireless devices, and non-transitory computer-readable medium described herein, the set of additional conditions include a speed of the first wireless device, a signal quality metric of wireless communications received by the first wireless device, network-based additional conditions, or any combination thereof.

In some examples of the method, first wireless devices, and non-transitory computer-readable medium described herein, the first set of conditions include one or more network settings, a radio resource control configuration, or both.

In some examples of the method, first wireless devices, and non-transitory computer-readable medium described herein, the one or more inferences include an inference associated with channel state feedback, an inference associated with one or more beams usable by the first wireless device, an inference associated with a geographical position of the first wireless device, or any combination thereof.

In some examples of the method, first wireless devices, and non-transitory computer-readable medium described herein, the functionality may be associated with one or more machine learning models executable by the first wireless device, the second wireless device, or both.

In some examples of the method, first wireless devices, and non-transitory computer-readable medium described herein, the first wireless device includes a UE and the second wireless device includes a network entity and the first wireless device includes the network entity and the second wireless device includes the UE.

Some examples of the method, first wireless devices, and non-transitory computer-readable medium described herein may further include operations, features, means, or instructions for monitoring a performance of the functionality based on performing the one or more inferences and determining that the functionality may be applicable for performing the one or more inferences based on monitoring the performance of the functionality.

### BRIEF DESCRIPTION OF THE DRAWINGS

FIG. 1 shows an example of a wireless communications system that supports techniques for additional condition indication based on model monitoring in accordance with one or more aspects of the present disclosure.

FIG. 2 shows an example of a wireless communications system that supports techniques for additional condition indication based on model monitoring in accordance with one or more aspects of the present disclosure.

FIG. 3 shows an example of a process flow that supports techniques for additional condition indication based on model monitoring in accordance with one or more aspects of the present disclosure.

FIG. 4 shows an example of a process flow that supports techniques for additional condition indication based on model monitoring in accordance with one or more aspects of the present disclosure.

FIG. 5 shows an example of a process flow that supports techniques for additional condition indication based on model monitoring in accordance with one or more aspects of the present disclosure.

FIGS. 6 and 7 show block diagrams of devices that support techniques for additional condition indication based on model monitoring in accordance with one or more aspects of the present disclosure.

FIG. 8 shows a block diagram of a communications manager that supports techniques for additional condition indication based on model monitoring in accordance with one or more aspects of the present disclosure.

FIG. 9 shows a diagram of a system including a device that supports techniques for additional condition indication based on model monitoring in accordance with one or more aspects of the present disclosure.

FIGS. 10 and 11 show flowcharts illustrating methods that support techniques for additional condition indication based on model monitoring in accordance with one or more aspects of the present disclosure.

### DETAILED DESCRIPTION

Some wireless devices (e.g., user equipments (UEs), network entities) may be configured to store and use machine learning models, such as neural network models, to make various inferences or predictions associated with wireless communications. Machine learning models may be used to infer or predict channel conditions (e.g., for channel state feedback), beam predictions, a location of the UE, and the like. For example, a UE may perform measurements on reference signals received from the network, and may input the measurements into a machine learning algorithm to predict relative qualities of receive (Rx) beams that should be used for future communications.

Machine learning models used within a wireless communications system may be generated or trained in a variety of ways. For example, in some cases, wireless devices may test out different models in a trial and error manner. However, such trial and error techniques may be very time consuming. Moreover, in cases where a wireless device finds that a machine learning model is useful for performing various inferences, the model may only be used by the respective wireless device that made the discovery, and may not be usable by other wireless devices within the network. In other cases, machine learning models may be trained to make specific inferences for a specific training dataset or test dataset. For example, a model may be trained to perform beam prediction in cases where the UE and the network entity are in a direct line of sight, and when a signal-to-noise ratio (SNR) is above a threshold. As such, the model may be used for performing beam prediction in a very specific set of circumstances or conditions (e.g., direct line of sight and SNR above a threshold). However, the model may additionally or alternatively be used for other circumstances or conditions that were not known at the time of training (e.g., for conditions that are out-of-distribution with respect to the training dataset or test dataset). For instance, the model may also be usable for non-direct-line-of-sight cases, or for cases where SNR is not above the threshold. As such, the model may be underutilized, which may cause the network to unnecessarily train additional models to make inferences or predictions in the same circumstances or conditions that may be covered by the previously trained mode.

Accordingly, aspects of the present disclosure are directed to techniques for identifying, defining, and updating machine learning models that are used to perform various inferences or predictions within a wireless communications system. In particular, aspects of the present disclosure are directed to signaling and configurations that enable wireless devices to: (1) initialize and define machine learning models that are to be used for inferences or predictions in specific sets of conditions, and (2) update machine learning models to apply the machine learning models to new or additional sets of conditions.

For example, a UE may test out different machine learning models for making inferences or predictions when communicating with a network entity. In this example, the UE or the network entity may determine that the model was useful or accurate in making the inferences or predictions, and may therefore define a model ID for the machine learning model so that the model can be referenced and used for a specific set of conditions in the future between that UE and network entity.

Continuing with the same example, the wireless devices may be configured to use the machine learning model for a specific set of conditions (e.g., RRC configurations, SNR, UE speed, line-of-sight, etc.) for which the model was previously trained or used. In such cases, through the use of the models and by monitoring their accuracy or performance, the wireless devices (e.g., UE, network entity) may determine that a model is also useful for making inferences or predictions for additional conditions. In such cases, the wireless devices may transmit signaling to those other wireless devices to update metadata associated with the model so that the model can be used in cases for the additional conditions, thereby expanding the use of the model to other conditions or circumstances. In this regard, the applicability of the models to different additional conditions may be crowd-sourced across different wireless devices within the network.

In some aspects, the determination that a particular model may be expanded or used for additional conditions may hold only for that UE, since a different UE may not use the same model. In this case, the network entity and that UE for which the model applicability was determined may update metadata associated with the model so that the model can be used in cases for the additional conditions, thereby expanding the use of the model to other conditions or circumstances. However, in some cases, the same physical model may be shared across other wireless devices.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to techniques for additional condition indication based on model monitoring.

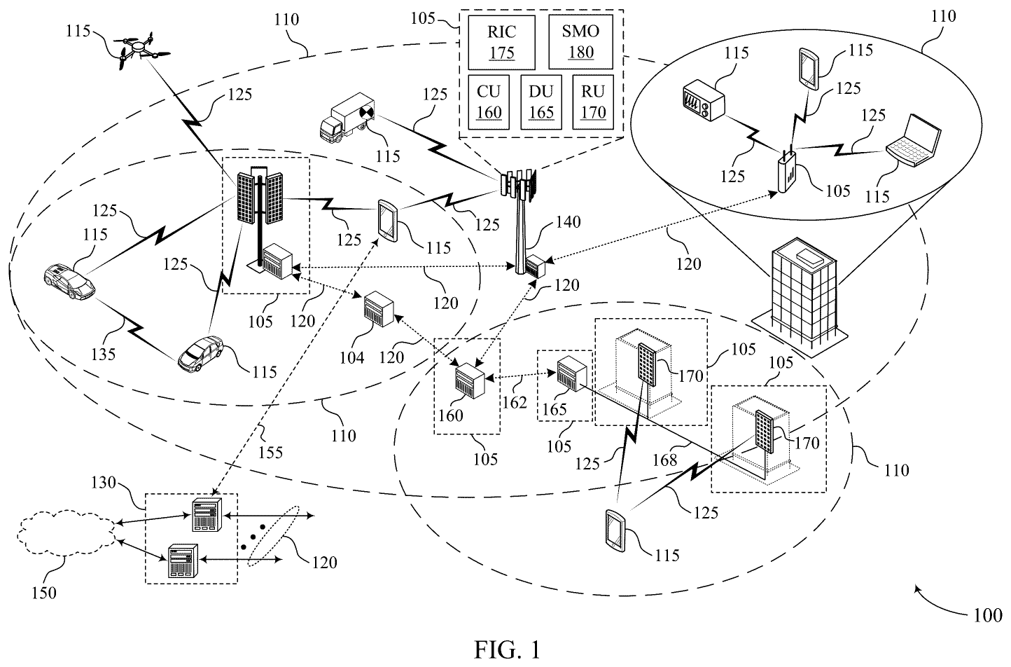

FIG. 1 shows an example of a wireless communications system 100 that supports techniques for additional condition indication based on model monitoring in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for additional condition indication based on model monitoring as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective wireless devices of the wireless communications system 100 (e.g., UEs 115, network entities 105, IAB nodes, etc.) may support techniques for identifying, defining, and updating machine learning models that are used to perform various inferences or predictions within the wireless communications system 100. In particular, the wireless communications system 100 may support signaling and configurations that enable wireless devices to: (1) initialize and define machine learning models that are to be used for inferences or predictions in specific sets of conditions, and (2) update machine learning models to apply the machine learning models to new or additional sets of conditions.

For example, a UE 115 of the wireless communications system 100 may test out different machine learning models for making inferences or predictions when communicating with a network entity. In this example, the UE 115 or the network entity 105 may determine that the model was useful or accurate in making the inferences or predictions, and may therefore define a model ID for the machine learning model so that the model can be referenced and used for a specific set of conditions in the future. Continuing with the same example, the wireless devices may be configured to use the machine learning model for a specific set of conditions (e.g., RRC configurations, SNR, UE speed, line-of-sight, etc.) for which the model was previously trained or used. In such cases, through the use of the models, the wireless devices (e.g., UE 115, network entity 105) may determine that a model is also useful for making inferences or predictions for additional conditions. In such cases, the wireless devices may transmit signaling to other wireless devices to update metadata associated with the model so that the model can be used in cases for the additional conditions, thereby expanding the use of the model to other conditions or circumstances. In this regard, the applicability of the models to different additional conditions may be crowd-sourced across different wireless devices within the network.

Techniques described herein may facilitate more efficient identification of machine learning models that may be used for performing inferences or predictions within a wireless communications system. By improving the ability of wireless devices to identify and define (e.g., assign a model ID to) machine learning models, techniques described herein may enable the wireless devices to distribute information associated with the identified model throughout the network, which may lead to more prevalent use of the model for making inferences or predictions, and therefore more efficient and reliable wireless communications. Moreover, techniques described herein may enable wireless devices to efficiently update previously trained machine learning models in order to apply the machine learning models to new sets of additional conditions for which the models were not originally trained. As such, aspects of the present disclosure may enable machine learning models to be extended to additional use-cases and scenarios (e.g., additional conditions), thereby increasing the use of the models and preventing the need for additional models to be trained for the additional conditions.

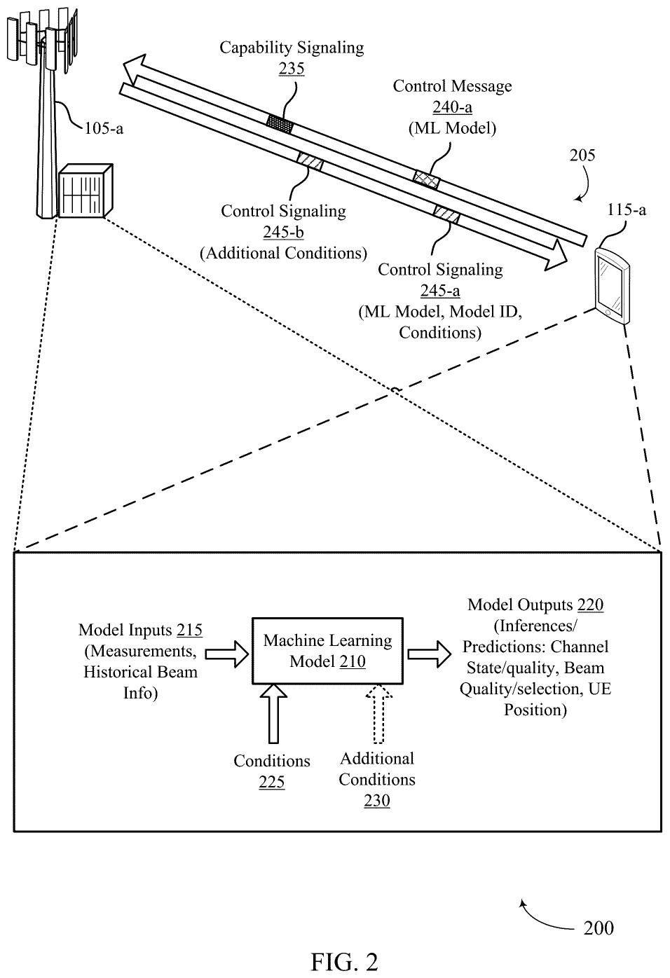

FIG. 2 shows an example of a wireless communications system 200 that supports techniques for additional condition indication based on model monitoring in accordance with one or more aspects of the present disclosure. In some examples, aspects of the wireless communications system 200 may implement, or be implemented by, aspects of the wireless communications system 100. In particular, the wireless communications system 200 may support techniques for identifying, defining, and updating machine learning models that are used to perform various inferences or predictions within the wireless communications system 100.

The wireless communications system 200 may include a UE 115-a and a network entity 105-a, which may be examples of wireless devices as described herein. In some aspects, the UE 115-a and the network entity 105-a may communicate with one another using a communication link 205, which may be an example of an NR or LTE link, a sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205, and one or more components of the network entity 105-a may transmit downlink signals, such as downlink control signals or downlink data signals, to the UE 115-a using the communication link 205.

As noted previously herein, some wireless devices (e.g., the UE 115-a, the network entity 105-a) may be configured to store and use machine learning models 210, such as neural network models, to make various inferences or predictions associated with wireless communications. As shown in FIG. 2, the machine learning model 210 may receive measurements as a model input 215, and make an inference or prediction as a model output 220. Machine learning models 210 may be used to infer or predict channel conditions (e.g., for channel state feedback), beam predictions, a location of the UE, and the like. For example, the UE 115-a may be configured may perform measurements on reference signals received from the network entity 105-a, and may input the measurements into a machine learning algorithm (e.g., the machine learning model 210) to predict relative qualities of Rx beams that should be used for future communications.

In this regard, one or more model inputs 215 may include, but are not limited to, measurements performed by the UE 115-a or the network entity 105-a, previous locations of the UE 115-a (e.g., historical location data), previous channel conditions between the respective devices, previous beams used to transmit or receive signals at the respective devices, and the like. One or more model outputs 220 may include various inferences or predictions performed by the machine learning model 210, including channel state information, channel quality information, beam quality, beam selections, UE position, etc.

One or more machine learning models 210 may be stored in memory at the respective devices (e.g., the network entity 105-a, the UE 115-a), retrieved from a remote database, and the like. One or more machine learning models 210 used within the wireless communications system 200 may be generated or trained in a variety of ways. For example, in some cases, wireless devices may test out different machine learning models 210 in a trial and error manner. However, such trial and error techniques may be very time consuming. Moreover, in cases where a wireless device finds that a machine learning model 210 is useful for performing various inferences (e.g., the model outputs 220), the machine learning model 210 may only be used by the respective wireless device that made the discovery, and may not be usable by other wireless devices within the network.

In other cases, the machine learning models 210 may be trained to make specific inferences (e.g., the model outputs 220) for a specific training dataset or test dataset, which may be referred to herein as conditions 225. For example, a model may be trained to perform beam prediction in cases where the UE 115-a and the network entity 105-a are in a direct line-of-sight, and when an SNRis above some threshold. As such, the model may be used for performing beam prediction in a very specific set of circumstances or conditions (e.g., direct line of sight and SNR above a threshold). In this example, the UE 115-a may use measurements as a model input 215, direct line-of-sight and low SNR as conditions 225, and may make beam inferences or beam predictions as a model output 220. However, the model may additionally or alternatively be used for other circumstances or conditions 225 that were not known at the time of training (e.g., for conditions that are out-of-distribution with respect to the training dataset or test dataset). For instance, the model may also be usable for non-direct-line-of-sight cases, or for cases where SNR is not above the threshold.

Stated differently, a machine learning model 210 (e.g., artificial intelligence (AI) model) may be expected to provide good inference accuracy (e.g., accurate inferences or predictions) if the input data samples at inference time resemble the data samples used to train the machine learning model 210. Specifically, the machine learning model 210 may only be expected to be accurate or reliable if the distribution of the test dataset used to make the inferences or predictions are within the distribution of the training dataset. Out-of-distribution samples (e.g., use-cases that fall outside of the training data used to train the model) may not provide accurate inference results since the loss function was not evaluated on such samples during the training optimization.

That is, the machine learning model 210 may only be expected to be accurate or reliable if the model is used with the same (or similar) model inputs 215 and conditions 225 as were used to train the model. For example, if the machine learning model 210 was trained to infer or predict the location of the UE 115-a in cases where the UE 115-a is outdoors with high SNR (e.g., conditions 225 are outdoors and high SNR), the machine learning model 210 may not be expected to be reliable or accurate in cases where the UE 115-a is indoors with low SNR.

The distribution of the training dataset (e.g., data used to train the machine learning model 210) may be described implicitly in the form of certain criteria associated with the collection of the training data. For example, the data collected when a UE 115-a is outdoors may have a specific distribution that may be different from the distribution of the data collected when the UE 115-a is indoors (hence why the model may not be accurate when the UE 115-a is indoors, since the model was only trained on data collected while the UE 115-a was outdoors).

The data or criteria (e.g., conditions 225) used to train machine learning models 210 may be network-sided (e.g., network settings, RRC configuration) or UE-sided (e.g., UE speed, SNR, UE location). Moreover, other data or criteria used to train the machine learning models 210 may be agnostic to the respective devices, such as the time of day, ambient temperatures, weather conditions, and the like. In other words, machine learning models 210 may be trained to make predictions or inferences for specific sets of criteria that may be associated with the UE 115-a, the network entity 105-a, external factors, or any combination thereof. For instance, a first machine learning model 210 may be trained or used to infer, predict, or estimate channel conditions for a first RRC configuration, and in cases where the UE 115-a is traveling less than 30 mph. Comparatively, a second machine learning model 210 may be trained or used to infer, predict, or estimate channel conditions for a specific set of network settings, and only for mornings between 6:00 am and 12:00 pm.

For the purposes of the present disclosure, the term “condition 225” may be used to refer to criteria associated with training or using a machine learning model 210 that a UE 115-a can report in via capability signaling (e.g., capability report). Comparatively, the term “additional conditions 230” may be used to refer to other criteria associated with training or using a machine learning model 210 that are not included in the capability report. For example, a quantity of communication layers supported by the UE 115-a or a quantity of antenna elements at the UE 115-a may be reported via UE capability signaling, and may therefore be referred to as “conditions 225” associated with the machine learning models 210 (e.g., a first model used for cases for a single communication layer, and a second model used for multiple communication layers). Comparatively, UE speed or location are not reported via UE capability signaling, and may therefore be referred to as “additional conditions 230.”

Stated differently, in the context of AI or machine learning models 210, the term “additional conditions 230” may be used to refer to any aspects that are assumed for the training of a machine learning model 210, but that are not a part of a reported UE capability for the AI-machine learning-enabled features. The additional conditions 230 may be divided into two categories: (1) network-side additional conditions, and (2) UE-side additional conditions.

Wireless communications systems may utilize various techniques to ensure that the machine learning models 210 are used in the correct context (e.g., for the intended conditions 225). For example, in the context of UE-side models (e.g., the machine learning models 210 implemented by the UE 115-a to perform inferences or predictions), in order to ensure consistency between training and inference regarding network-side additional conditions 230 (if identified), the network entity 105-a may explicitly indicate (to the UE 115-a) the machine learning model 210 that is to be used by the UE 115-a in order to achieve alignment on the network-side additional conditions 230 between network-side and UE-side. In this example, the network entity 105-a may know (e.g., be aware of) the conditions 225 and the additional conditions 230 used to train the machine learning model 210, and may assign or indicate a model ID to the UE 115-a.

In other cases, the network entity 105-a may train a machine learning model 210 and transfer (e.g., indicate, transmit) the model to the UE 115-a. In this example, the model may be trained for specific additional conditions 230. By way of another example, information or indication associated with network-side additional conditions 230 may be provided to the UE 115-a (such that the UE 115-a can identify the network-side additional conditions 230 for which a given machine learning model 210 is usable or useful). In yet other cases, consistency for model usage may be assisted by monitoring (e.g., by UE 115-a or network entity 105-a, the performance of UE-side candidate models or functionalities to select a model or functionality). These approaches for ensuring consistency between training and inference regarding network-side additional conditions 230 exhibit some overlap with one another, and wireless communications systems may utilize additional or alternative approaches for ensuring consistency with the use of the machine learning models 210 across devices.

In some cases, the criteria or conditions 225 used to train a machine learning model 210 may not be fully known or decided at the time the model is trained. In such cases, it may not be clear which conditions 225 the machine learning model 210 may actually be used for. As an example, the training dataset for training a machine learning model 210 may have been collected under a specific network setting A (e.g., condition A, a first condition 225). However, the same machine learning model 210 may also work well in a different setting B (e.g., condition B, a second condition 225) if the data distribution remains the same, or if the data distribution under setting B is covered by the data distribution under setting A. In such cases, wireless devices may only utilize the model under setting A, and may not know that the model is also useful under setting B.

For instance, a machine learning model 210 may be used to infer channel conditions in the morning (e.g., the condition 225 or training data set is morning time), when the network entity 105-a utilizes a specific set of network settings (which may be based on traffic, a quantity of UEs 115, etc.). In this example, the wireless devices may only utilize the model in the mornings, since the model was only trained on data collected during morning time. However, the model may also be useful in the evenings when the network entity 105-a utilizes the same or similar set of network settings. As such, even though the test data set (e.g., communications in the evenings) is different than the training data set (e.g., communications in the mornings), the model may nonetheless be useful in the evenings when the same or similar set of network settings is used.

As described previously herein, there are a few approaches to ensure that the machine learning model 210 selected to perform inferences or predictions is well-suited to the current situation in which the model will be used (e.g., ensure the additional conditions 230 at inference time are consistent with the training dataset distribution). In some cases, a model identification process may be used to bring the network entity 105-a and the UE 115-a to a common understanding on aspects related to a machine learning model 210 that is to be used (including the criteria applicable to the model's usage), where the network entity 105-a may subsequently indicate a model ID to the UE 115-a for the machine learning model 210 that is well-suited for the current situation (e.g., well suited for the current conditions 225 and the additional conditions 230). In additional or alternative implementations, if the network entity 105-a knows the criteria assumed while training the machine learning model 210, then the network entity 105-a may select a model suited to the current situation and transfer the model to the UE 115-a, or indicate the assumed criteria to the UE 115-a to allow the UE 115-a to select a model.

However, for cases where the criteria (e.g., the conditions 225, the additional conditions 230) for the model are not fully known at training time, such implementations may not work. In such cases, achieving consistency for model usage may require a trial-and-error type of operation based on a model monitoring approach, which may result in increased latency or control signaling overhead.

Accordingly, aspects of the present disclosure are directed to techniques for identifying, defining, and updating machine learning models 210 that are used to perform various inferences or predictions within the wireless communications system 200. In particular, aspects of the present disclosure are directed to signaling and configurations that enable wireless devices to: (1) initialize and define the machine learning models 210 that are to be used for inferences or predictions in specific sets of conditions 225, and (2) update machine learning models 210 to apply the machine learning models 210 to new or additional conditions 230.

Referring to FIG. 2, the UE 115-a may transmit capability signaling 235 to the network entity 105-a. The capability signaling 235 may indicate various capabilities of the UE 115-a. Moreover, as described previously herein, the capability signaling 235 may be used to indicate the conditions 225 associated with the UE 115-a, such as a quantity of communication layers supported at the UE 115-a, a quantity of antenna elements at the UE 115-a, etc.

The wireless devices of the wireless communications system 200 may perform initial model identification in order to tag a machine learning model 210 as being applicable for use under a (new) condition 225 or additional condition 230 that is determined based on model monitoring performed at the network entity 105-a, the current UE 115-a, or by other UEs 115 in the network. In other words, the network may crowd source initial model identification across UEs 115 and other wireless devices in the network, where the various wireless devices test out different machine learning models 210 to determine which conditions 225 or additional conditions 230 the models are usable for.

For example, in the context of initial model identification, the network entity 105-a and the UE 115-a may communicate with one another via the communication link 205. Through the communications, the wireless devices may perform model monitoring in which the UE 115-a or the network entity 105-a test out different machine learning models 210 for making various inferences or predictions. For example, during model monitoring, the UE 115-a may perform measurements on signals received from the network entity 105-a, and may use the measurements as model inputs 215 to various machine learning models 210 to make inferences or predictions (e.g., the model outputs 220). During the model monitoring process, the wireless devices may determine which conditions 225 or additional conditions 230 the machine learning model 210 is accurate, reliable, or otherwise usable for.

Continuing with the same example, based on identifying a machine learning model 210 that is usable for a set of conditions 225 or additional conditions 230, the UE 115-a may transmit a control message 240-a to the network entity 105-a, where the control message 240-a indicates the machine learning model 210, the set of conditions 225, or the set of additional conditions 230 for the model. The network entity 105-a may therefore identify the conditions 225 or additional conditions 230 for which the machine learning model 210 works well. Based on receiving the control message 240-a, the network entity 105-a may assign a model ID to the machine learning model 210, and may save the machine learning model 210, the model ID, the conditions 225, or additional conditions 230 for the model in memory (e.g., save a data object or metadata associated with the machine learning model 210).

The network entity 105-a may transmit control signaling 245-a to the UE 115-a, where the control signaling indicates a model ID, the set of conditions 225, or additional conditions 230 for which the model works well. Such an annotation may be included in the model metadata and may be indicated during initial model identification. Based on the determination, the network entity 105-a may use the conditions 225 or the additional conditions 230 for life-cycle management operations such as model selection and switching. In other words, the network entity 105-a may assign a model ID to the machine learning model 210 so that the machine learning model 210 may be referenced and used in the future. Based on receiving the control signaling 245-a, the UE 115-a may assign the model ID to the machine learning model 210, and may save the machine learning model 210, the model ID, the conditions 225, or the additional conditions 230 for the model in memory (e.g., save a data object or metadata associated with the machine learning model 210).

Similar steps or procedures may be used for model re-identification or updating. In the context of model re-identification, a previously identified and previously trained machine learning model 210 may be tagged as being applicable for use under new additional conditions 230 that are different from the additional conditions 230 for which the model was trained or indicated during model identification. Stated differently, as the machine learning model 210 is used by the UE 115-a or the network entity 105-a, the wireless devices may identify new additional conditions 230 for which the model is accurate, reliable, or otherwise useful, and may update or re-annotate the model as being applicable to the newly identified additional conditions 230. Such a re-annotation may update the metadata associated with the machine learning model 210 that was initially indicated during model identification. In other words, the UE 115-a, the network entity 105-a, or both, may update a data object or metadata for the machine learning model 210 based on the newly identified additional conditions 230 applicable to the model.

New additional conditions 230 for model re-identification or re-annotation may be identified based on model monitoring performed at the network entity 105-a, the current UE 115-a, or other UEs 115 within the network. For example, as described previously herein, the network entity 105-a may use the machine learning model 210 for the conditions 225 or additional conditions 230 originally identified during the model identification process, as well as for other additional conditions 230. In this regard, the network entity 105-a may identify that the model is accurate, reliable, or otherwise usable for making inferences or predictions for new additional conditions 230 that were not originally identified during model identification or training. Based on identifying the new additional conditions 230 for the model, the network entity 105-a may re-identify, re-annotate, or otherwise update the data object or metadata associated with the machine learning model 210 based on the newly identified additional conditions 230.

In this example, the network entity 105-a may transmit a control signaling 245-b to the UE 115-a, where the control signaling 245-b indicates the newly identified additional conditions 230 for which the machine learning model 210 is usable. Such a re-annotation may be included in the model metadata. Based on the re-annotation, the network entity 105-a may use the new additional conditions 230 for life-cycle management operations such as model selection and switching. Based on receiving the control signaling 245-b, the UE 115-a may update the machine learning model 210 with the additional conditions 230 (e.g., update the data object or metadata associated with the machine learning model 210). In other words, the network entity 105-a and the UE 115-a may update the data object or metadata for the machine learning model 210 so that the updated (e.g., re-annotated) model may be referenced and used in the future.

The model identification or re-identification (e.g., update, annotation) processes described herein may be performed in either direction (e.g., from the UE 115-a to the network entity 105-a, or vice versa) for both UE-side and network-side additional conditions 230. For example, model identification or re-identification may be in the form of an indication or information about the new network-side additional conditions 230, being sent from the network entity 105-a to the UE 115-a, where the network entity 105-a may identify a new criterion (e.g., new additional conditions 230) in which the machine learning model 210 is observed to perform well. Conversely, as described previously herein, identification or re-identification may also happen from UE 115-a to the network entity 105-a in the form of a report from the UE 115-a to the network entity 105-a about the new UE-side additional conditions 230, where the UE 115-a may identify a new criterion (e.g., new additional conditions 230) in which the machine learning model 210 is observed to perform well.

In some aspects, initial model identification and model re-annotation may be implicit without referring to any explicit signaling of conditions from the network entity 105-a. For example, the UE 115-a may transmit a message or report to the network entity 105-a that indicates the UE 115-a has identified a machine learning model 210 that works well for whichever conditions 225 or additional conditions 230 the network entity 105-a is currently using. In this example, the UE 115-a may not know the actual conditions 225 or additional conditions 230 being used by the network entity 105-a, but may request that the model be identified (e.g., assigned a model ID) so that the model may be used for future occasions where the network entity 105-a uses the same conditions 225 or additional conditions 230 (e.g., used in subsequent life cycle management (LCM)). As such, the procedure may involve assigning a model ID or updating a model ID associated with the machine learning model 210.

While much of the present disclosure is described in the context of machine learning models 210 that may be known or identified at both the UE 115-a and the network entity 105-a, this is not to be regarded as a limitation of the present disclosure, unless noted otherwise herein. In particular, in some cases, the machine learning model 210 at the UE 115-a may be transparent to the network. In other words, the network entity 105-a may not know which machine learning models 210 (or how many machine learning models 210) may be implemented at the UE 115-a.

In such cases, in order to enable the UE 115-a to implement machine learning models 210 that are transparent (e.g., not known) to the network entity 105-a, the devices may instead exchange signaling directed to different functionalities. For the purpose of the present disclosure, the term “functionality” may be used to refer to a configuration that may be referenced by both the UE 115-a and the network entity 105-a, where the functionality or configuration is usable by the UE 115-a to implement one or more machine learning models 210. As such, the network entity 105-a may be able to identify, update, and indicate various functionalities (e.g., configurations) that are used by the UE 115-a to implement machine learning models 210, even in cases where the network entity 105-a is blind to the actual machine learning models 210 being implemented.

For example, the process for functionality identification may be similar to the process for model identification described herein. In the context of functionality identification, the network entity 105-a and the UE 115-a may communicate with one another via the communication link 205. Through the communications, the wireless devices may perform functionality monitoring in which the UE 115-a or the network entity 105-a test out functionalities (e.g., configurations for the machine learning models 210) for making various inferences or predictions. During the functionality monitoring process, the wireless devices may determine which conditions 225 or additional conditions 230 for which a given functionality is accurate, reliable, or otherwise usable.

Continuing with the same example, based on identifying a functionality that is usable for a set of conditions 225 or additional conditions 230, the UE 115-a may transmit a control message 240-a to the network entity 105-a, where the control message 240-a indicates the functionality, the set of conditions 225, or the set of additional conditions 230 for the functionality. The network entity 105-a may therefore identify the conditions 225 or the additional conditions 230 for which the functionality works well. Based on receiving the control message 240-a, the network entity 105-a may assign a functionality ID to the functionality, and may save the functionality, the functionality ID, the conditions 225, the additional conditions 230, or a combination thereof for the functionality in memory (e.g., save a data object or metadata associated with the functionality). The network entity 105-a may transmit control signaling 245-a to the UE 115-a, where the control signaling indicates a functionality ID, the set of conditions 225, or the additional conditions 230 for which the functionality works well. Such an annotation may be included in the functionality metadata and may be indicated during initial functionality identification. Based on the determination, the network entity 105-a may use the conditions 225 or the additional conditions 230 for life-cycle management operations such as functionality selection and switching. In other words, the network entity 105-a may assign a functionality ID to the functionality so that the functionality may be referenced and used in the future. Based on receiving the control signaling 245-a, the UE 115-a may assign the functionality ID to the functionality, and may save the functionality, the functionality ID, the conditions 225, the additional conditions 230, or a combination thereof for the functionality in memory (e.g., save a data object or metadata associated with the functionality).

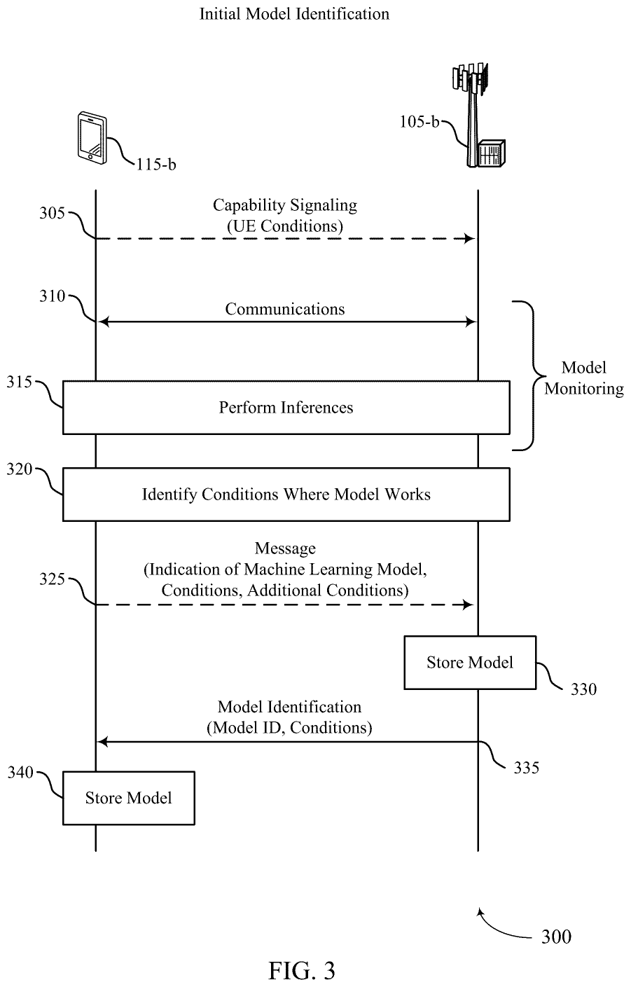

FIG. 3 shows an example of a process flow 300 that supports techniques for additional condition indication based on model monitoring in accordance with one or more aspects of the present disclosure. In some examples, aspects of the process flow 300 may implement, or be implemented by, aspects of wireless communications systems 100, the wireless communications system 200, or both. For example, process flow 300 illustrates signaling used for initial model identification, as described previously herein.

The process flow 300 includes a UE 115-b and a network entity 105-b, which may be examples of wireless devices as described herein. For example, the UE 115-b and the network entity 105-b illustrated in FIG. 3 may include examples of the UE 115-a and the network entity 105-a, respectively, as illustrated in FIG. 2.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

As described previously herein, wireless devices (e.g., the UE 115-b, the network entity 105-b) may perform initial model identification shown in FIG. 3 in order to tag a machine learning model 210 as being applicable for use under a (new) condition 225 or additional condition 230 that is determined based on model monitoring performed at the network entity 105-b, the current UE 115-b, or by other UEs 115 in the network. In other words, the network may crowd source initial model identification across the UEs 115 and other wireless devices in the network, where the various wireless devices test out different machine learning models 210 to determine for which conditions 225 or additional conditions 230 the models are usable.

At 305, the UE 115-b may transmit capability signaling to the network entity 105-b. The capability signaling may indicate various capabilities of the UE 115-b. Moreover, as described previously herein, the capability signaling may be used to indicate conditions associated with the UE 115-b, such as a quantity of communication layers supported at the UE 115-b, a quantity of antenna elements at the UE 115-b, etc.

At 310, the UE 115-b and the network entity 105-b may communicate with one another. That is, the UE 115-b may transmit uplink signals or uplink messages to the network entity 105-b, and the network entity 105-b may transmit downlink signals or downlink messages to the UE 115-b. The wireless devices may perform the communications using various network-side conditions and UE-side conditions. Moreover, as described previously herein, the wireless devices may perform the communications using various additional conditions. Further, the wireless devices may perform the communications at 310 based on transmitting or receiving the capability signaling at 305.

At 315, the UE 115-b, the network entity 105-b, or both, may utilize one or more machine learning models to make inferences or predictions. In other words, the wireless devices may test out different machine learning models in a trial-and-error manner. The wireless devices may perform the inferences or predictions at 315 based on transmitting or receiving the capability signaling at 305, performing the communications at 310, or both.

For example, through the communications at 310, the wireless devices may perform model monitoring in which the UE 115-b or the network entity 105-b test out different machine learning models for making various inferences or predictions. For example, during model monitoring, the UE 115-b may perform measurements on signals received from the network entity 105-b, and may use the measurements as model inputs to various machine learning models to make inferences or predictions (e.g., model outputs).

At 320, the UE 115-a, the network entity 105-b, or both, may identify conditions (e.g., the conditions 225) or additional conditions (e.g., the additional conditions 230) for which a machine learning model is accurate, reliable, or otherwise usable for. In some cases, a machine learning model that is usable for one or more conditions may be referred to as applicable to such one or more conditions.

At 325, in cases where the UE 115-a identifies a model that is usable for a set of conditions or additional conditions, the UE 115-b may transmit a control message (e.g., the control message 240-a) to the network entity 105-b, where the control message indicates the identified machine learning model, the set of conditions, or the set of additional conditions for the model.

At 330, the network entity 105-b may assign a model ID to the machine learning model, and may save the machine learning model, a model ID, or the conditions or additional conditions for the model in memory (e.g., save a data object or metadata associated with the machine learning model). The network entity 105-b may save the data object or metadata for the machine learning model at 330 based on identifying the conditions or additional conditions for the model at 320, receiving the control message from the UE 115-b at 325, or both.

At 335, the network entity 105-b may transmit control signaling to the UE 115-b, where the control signaling indicates the model ID or the set of conditions or additional conditions for which the model works well.

At 340, the UE 115-b may assign the model ID to the machine learning model 210, and may save the machine learning model 210, the model ID, the conditions 225, the additional conditions 230, or a combination thereof for the model in memory (e.g., save a data object or metadata associated with the machine learning model 210).

After identifying the model and assigning a model ID, the wireless devices may be able to reference the model (e.g., via the model ID) in order to utilize the machine learning model for inferences or predictions in the future. Moreover, in some cases, the network entity 105-b or the UE 115-b may be able to share the model ID with other wireless devices within the network.

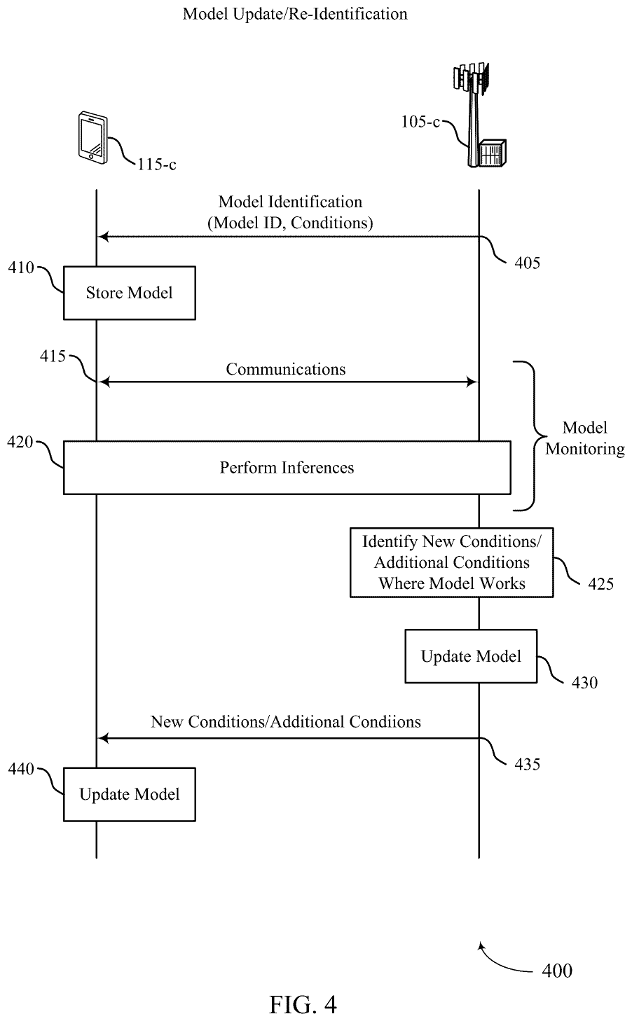

FIG. 4 shows an example of a process flow 400 that supports techniques for additional condition indication based on model monitoring in accordance with one or more aspects of the present disclosure. In some examples, aspects of the process flow 400 may implement, or be implemented by, aspects of wireless communications systems 100, the wireless communications system 200, the process flow 300, or any combination thereof. For example, process flow 300 illustrates signaling used for model updating or re-identification, as described previously herein.

The process flow 400 includes a UE 115-c and a network entity 105-c, which may be examples of wireless devices as described herein. For example, the UE 115-c and the network entity 105-c illustrated in FIG. 4 may include examples of the UE 115-a and the network entity 105-a, respectively, as illustrated in FIG. 2. Moreover, the UE 115-c and the network entity 105-c illustrated in FIG. 4 may include examples of the UE 115-b and the network entity 105-b, respectively, as illustrated in FIG. 3.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

In some aspects, the steps of process flow 400 for updating or re-identifying a machine learning model may be performed after the steps of process flow 300 during which a machine learning model was initially identified. For example, in some cases, steps 405 and 410 of process flow 400 may be the same as steps 335 and 340 of process flow 300. In this regard, process flow 400 may illustrate steps or functions used to update or re-identify the machine learning model that was initially identified in process flow 300.

At 405, the network entity 105-c may transmit control signaling to the UE 115-c, where the control signaling indicates a model ID or the set of conditions or additional conditions for which a machine learning model. In some cases, step 405 may be the same as step 335 from process flow 300.

At 410, the UE 115-c may assign the model ID to the machine learning model, and may save the machine learning model, the model ID, the conditions, the additional conditions, or a combination thereof for the model in memory (e.g., save a data object or metadata associated with the machine learning model). In some cases, step 410 may be the same as step 340 from process flow 300.

At 415, the UE 115-c and the network entity 105-c may communicate with one another. That is, the UE 115-c may transmit uplink signals or uplink messages to the network entity 105-c, and the network entity 105-c may transmit downlink signals or downlink messages to the UE 115-c. The wireless devices may perform the communications using various network-side conditions and UE-side conditions. Moreover, as described previously herein, the wireless devices may perform the communications using various additional conditions. Further, the wireless devices may perform the communications at 415 based on receiving or transmitting the indication of the machine learning model at 405, storing the machine learning model at 410, or both.

At 420, the UE 115-c, the network entity 105-c, or both, may utilize the indicated machine learning model to make inferences or predictions. In some aspects, the wireless devices may utilize the machine learning model both for the conditions or the additional conditions for which the model was originally identified or trained, as well as new conditions or additional conditions. The wireless devices may perform the inferences or predictions at 420 based on receiving or transmitting the indication of the machine learning model at 405, storing the machine learning model at 410, performing the communications at 415, or any combination thereof.

At 425, the network entity 105-c may identify new conditions (e.g., the conditions 225) or new additional conditions (e.g., the additional conditions 230) for which the machine learning model is accurate, reliable, or otherwise usable.

At 430, the network entity 105-c may update a data object (e.g., metadata) associated with the machine learning model based on (e.g., to include) the newly identified conditions or additional conditions for the model (e.g., update the data object or metadata associated with the machine learning model). The network entity 105-c may save the data object or metadata for the machine learning model at 430 based on identifying the new conditions or additional conditions for the model at 425.

At 435, the network entity 105-c may transmit control signaling to the UE 115-c, where the control signaling indicates for the UE 115-c to update the machine learning model with the newly identified conditions or additional conditions.

At 445, the UE 115-c may update the machine learning model based on (e.g., to include) the newly identified conditions or additional conditions for the model (e.g., update a saved data object or metadata associated with the machine learning model).

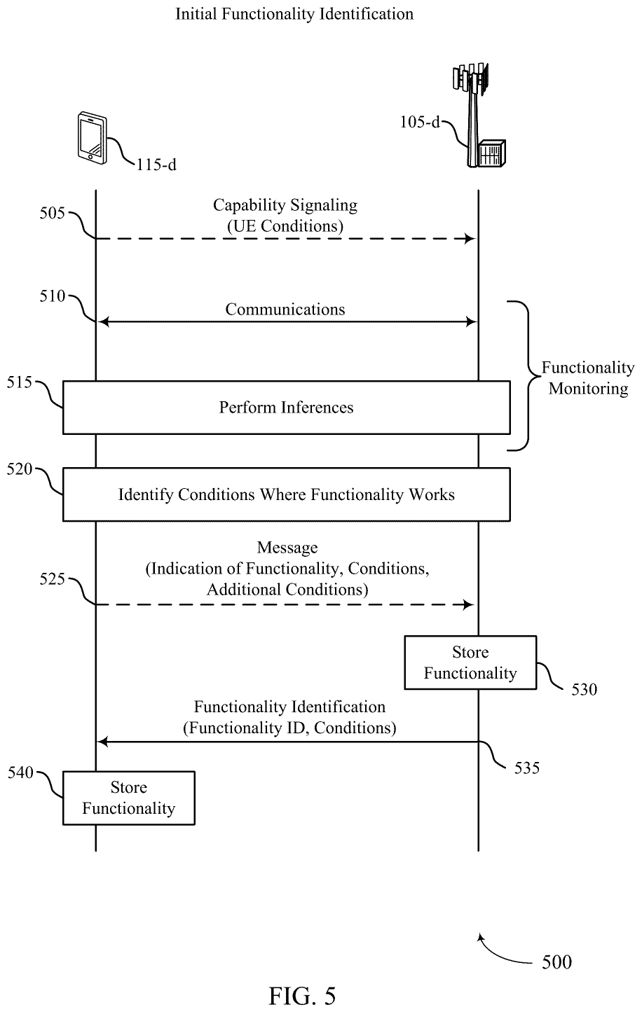

FIG. 5 shows an example of a process flow 500 that supports techniques for additional condition indication based on model monitoring in accordance with one or more aspects of the present disclosure. In some examples, aspects of the process flow 400 may implement, or be implemented by, aspects of wireless communications systems 100, the wireless communications system 200, the process flow 300, the process flow 400, or any combination thereof. For example, process flow 500 illustrates signaling used for initial functionality identification, as described previously herein.

The process flow 500 includes a UE 115-d and a network entity 105-d, which may be examples of wireless devices as described herein. For example, the UE 115-d and the network entity 105-d illustrated in FIG. 5 may include examples of the UE 115-a and the network entity 105-a, respectively, as illustrated in FIG. 2. Moreover, the UE 115-d and the network entity 105-d illustrated in FIG. 5 may include examples of the UEs 115-b, 115-c and the network entities 105-b, 105-c, respectively, as illustrated in FIGS. 3-4.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

As described previously herein, in some cases, machine learning models used at the UE 115-d may be transparent to the network entity 105-d. In other words, the network entity 105-d may not know which models (or how many models) may be implemented at the UE 115-a. In such cases, in order to enable the UE 115-d to implement machine learning models that are transparent (e.g., not known) to the network entity 105-d, the devices may instead exchange signaling directed to different “functionalities.” For the purpose of the present disclosure, the term “functionality” may be used to refer to a configuration that may be referenced by both the UE 115-d and the network entity 105-d, where the functionality or configuration is usable by the UE 115-d to implement one or more machine learning models. As such, the network entity 105-d may be able to identify, update, and indicate various functionalities (e.g., configurations) that are used by the UE 115-d to implement machine learning models, even in cases where the network entity 105-d is blind to the actual machine learning models being implemented.

The wireless devices (e.g., the UE 115-d, the network entity 105-d) may perform initial functionality identification shown in FIG. 5 in order to “tag” a functionality as being applicable for use under a (new) condition or additional condition that is determined based on functionality monitoring performed at the network entity 105-d, the current UE 115-d, or by other UEs 115 in the network. In other words, the network may crowd source initial functionality identification across UEs 115 and other wireless devices in the network, where the various wireless devices test out different functionalities to determine which conditions or additional conditions the functionalities are usable for.

At 505, the UE 115-d may transmit capability signaling to the network entity 105-d. The capability signaling may indicate various capabilities of the UE 115-d. Moreover, as described previously herein, the capability signaling may be used to indicate conditions 225 associated with the UE 115-d, such as a quantity of communication layers supported at the UE 115-d, a quantity of antenna elements at the UE 115-d, etc.

At 510, the UE 115-d and the network entity 105-d may communicate with one another. That is, the UE 115-d may transmit uplink signals or uplink messages to the network entity 105-d, and the network entity 105-d may transmit downlink signals or downlink messages to the UE 115-d. The wireless devices may perform the communications using various network-side conditions and UE-side conditions. Moreover, as described previously herein, the wireless devices may perform the communications using various additional conditions. Further, the wireless devices may perform the communications at 510 based on transmitting or receiving the capability signaling at 505.

At 515, the UE 115-d, the network entity 105-d, or both, may utilize one or more functionalities to make inferences or predictions. In other words, the wireless devices may test out different functionalities in a trial-and-error manner. The wireless devices may perform the inferences or predictions at 515 based on transmitting or receiving the capability signaling at 505, performing the communications at 510, or both.

For example, through the communications at 510, the wireless devices may perform functionality monitoring in which the UE 115-d or the network entity 105-d test out different functionalities for making various inferences or predictions. For example, during functionality monitoring, the UE 115-d may perform measurements on signals received from the network entity 105-d, and may use the measurements as functionality inputs to various functionalities to make inferences or predictions (e.g., functionality outputs).

At 520, the UE 115-a, the network entity 105-d, or both, may identify conditions (e.g., conditions 225) or additional conditions (e.g., additional conditions 230) for which a functionality is accurate, reliable, or otherwise usable for.

At 525, in cases where the UE 115-a identifies a functionality that is usable for a set of conditions or additional conditions, the UE 115-d may transmit a control message (e.g., control message 240-a) to the network entity 105-d, where the control message indicates the identified functionality, the set of conditions, or the set of additional conditions for the functionality.

At 530, the network entity 105-d may assign a functionality ID to the functionality, and may save the functionality, a functionality ID, or the conditions or additional conditions for the functionality in memory (e.g., save a data object or metadata associated with the functionality). The network entity 105-d may save the data object or metadata for the functionality at 530 based on identifying the conditions or additional conditions for the functionality at 520, receiving the control message from the UE 115-d at 525, or both.

At 535, the network entity 105-d may transmit control signaling to the UE 115-d, where the control signaling indicates the functionality ID or the set of conditions or additional conditions for which the functionality works well.

At 540, the UE 115-d may assign the functionality ID to the functionality, and may save the functionality, the functionality ID, or the conditions or additional conditions for the functionality in memory (e.g., save a data object or metadata associated with the functionality).

After identifying the functionality and assigning a functionality ID, the wireless devices may be able to reference the functionality (e.g., via the functionality ID) in order to utilize the functionality for or inferences or predictions in the future. Moreover, in some cases, the network entity 105-d or the UE 115-d may be able to share the functionality ID with other wireless devices within the network.

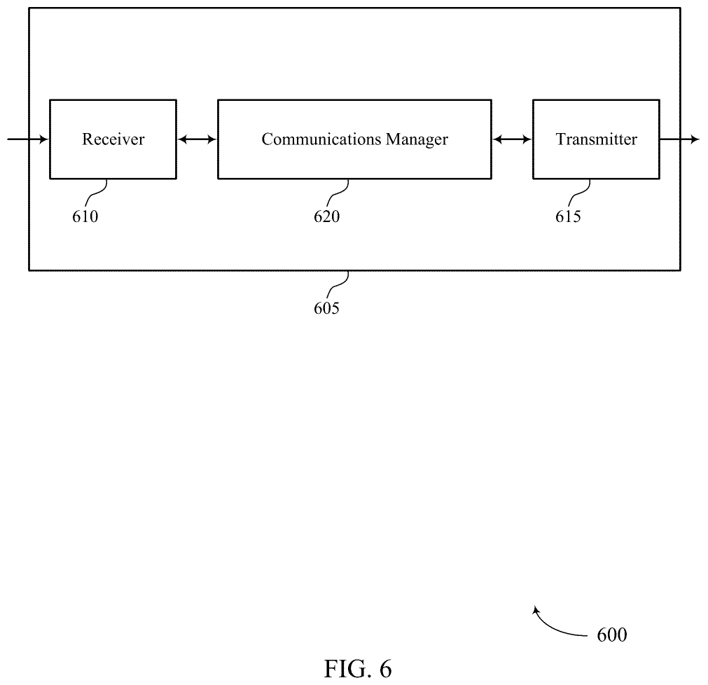

FIG. 6 shows a block diagram 600 of a device 605 that supports techniques for additional condition indication based on model monitoring in accordance with one or more aspects of the present disclosure. The device 605 may be an example of aspects of a UE 115, a network entity 105, or both, as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for additional condition indication based on model monitoring). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for additional condition indication based on model monitoring). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for additional condition indication based on model monitoring as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for communicating signaling with a second wireless device, an additional wireless device, or both. The communications manager 620 is capable of, configured to, or operable to support a means for performing, based on the communication of the signaling, one or more inferences using a machine learning model. The communications manager 620 is capable of, configured to, or operable to support a means for transmitting, to the second wireless device, an indication that the machine learning model was applicable for performing the one or more inferences. The communications manager 620 is capable of, configured to, or operable to support a means for receiving, from the second wireless device, control signaling indicating that the machine learning model is applicable for communications that are associated with a first set of conditions associated with the communication of the signaling, where the control signaling indicates a model ID associated with the machine learning model, that the first set of conditions is associated with the machine learning model, or both.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for facilitating more efficient identification of machine learning models that may be used for performing inferences or predictions within a wireless communications system. By improving the ability of wireless devices to identify and define (e.g., assign a model ID) to machine learning models, techniques described herein may enable the wireless devices to distribute information associated with the identified model throughout the network, which may lead to more prevalent use of the model for making inferences or predictions, and therefore more efficient and reliable wireless communications. Moreover, techniques described herein may enable wireless devices to efficiently update previously trained machine learning models in order to apply the machine learning models to new sets of additional conditions for which the models were not originally trained. As such, aspects of the present disclosure may enable machine learning models to be extended to additional use-cases and scenarios (e.g., additional conditions), thereby increasing the use of the models and preventing the need for additional models to be trained for the additional conditions.

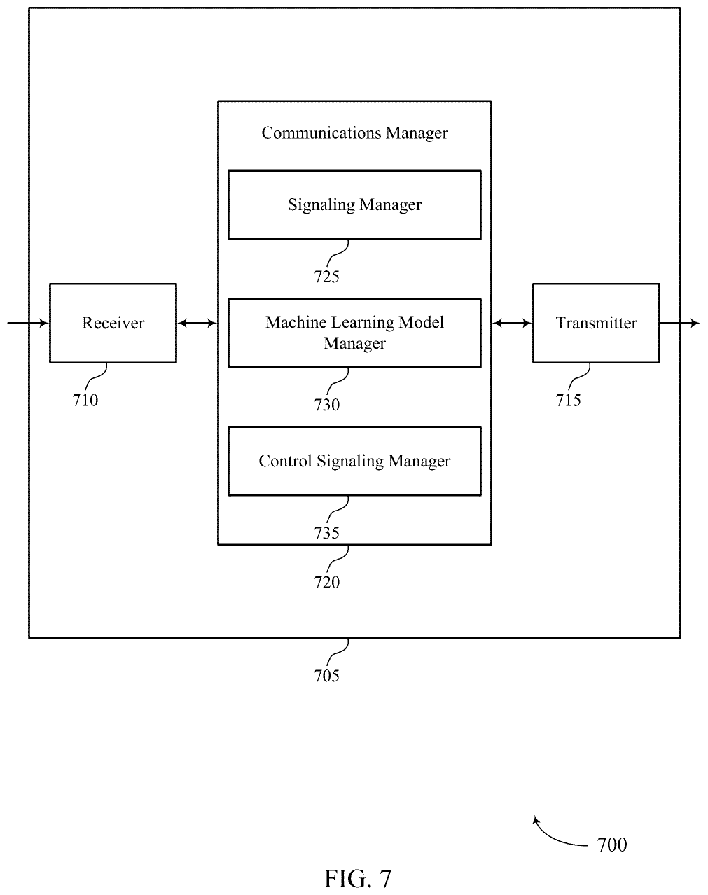

FIG. 7 shows a block diagram 700 of a device 705 that supports techniques for additional condition indication based on model monitoring in accordance with one or more aspects of the present disclosure. The device 705 may be an example of aspects of a device 605, a UE 115, or a network entity 105, as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for additional condition indication based on model monitoring). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for additional condition indication based on model monitoring). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for additional condition indication based on model monitoring as described herein. For example, the communications manager 720 may include a signaling manager 725, a machine learning model manager 730, a control signaling manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The signaling manager 725 is capable of, configured to, or operable to support a means for communicating signaling with a second wireless device, an additional wireless device, or both. The machine learning model manager 730 is capable of, configured to, or operable to support a means for performing, based on the communication of the signaling, one or more inferences using a machine learning model. The signaling manager 725 is capable of, configured to, or operable to support a means for transmitting, to the second wireless device, an indication that the machine learning model was applicable for performing the one or more inferences. The control signaling manager 735 is capable of, configured to, or operable to support a means for receiving, from the second wireless device, control signaling indicating that the machine learning model is applicable for communications that are associated with a first set of conditions associated with the communication of the signaling, where the control signaling indicates a model ID associated with the machine learning model, that the first set of conditions is associated with the machine learning model, or both.

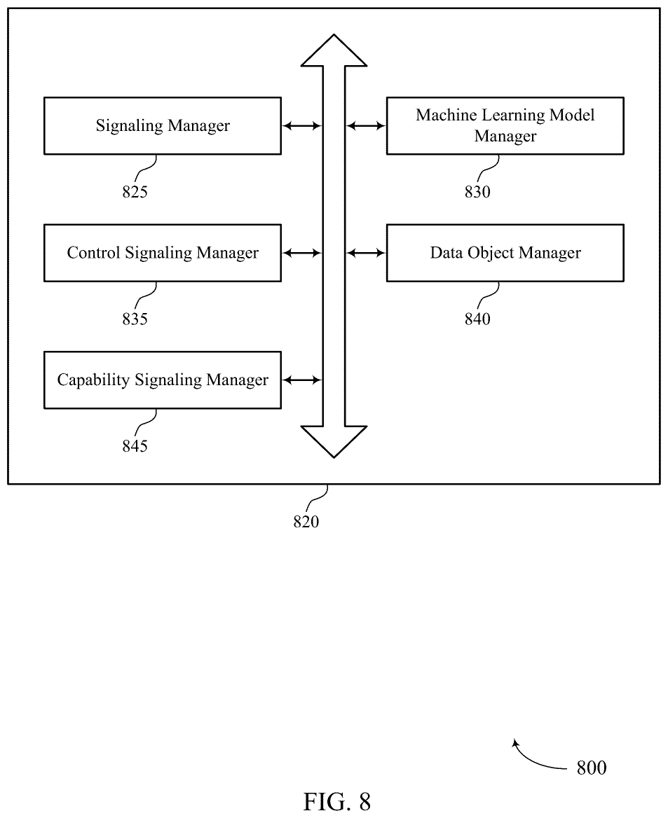

FIG. 8 shows a block diagram 800 of a communications manager 820 that supports techniques for additional condition indication based on model monitoring in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for additional condition indication based on model monitoring as described herein. For example, the communications manager 820 may include a signaling manager 825, a machine learning model manager 830, a control signaling manager 835, a data object manager 840, a capability signaling manager 845, or any combination thereof. Each of these components, or components or subcomponents thereof (e.g., one or more processors, one or more memories), may communicate, directly or indirectly, with one another (e.g., via one or more buses).

The signaling manager 825 is capable of, configured to, or operable to support a means for communicating signaling with a second wireless device, an additional wireless device, or both. The machine learning model manager 830 is capable of, configured to, or operable to support a means for performing, based on the communication of the signaling, one or more inferences using a machine learning model. In some examples, the signaling manager 825 is capable of, configured to, or operable to support a means for transmitting, to the second wireless device, an indication that the machine learning model was applicable for performing the one or more inferences. The control signaling manager 835 is capable of, configured to, or operable to support a means for receiving, from the second wireless device, control signaling indicating that the machine learning model is applicable for communications that are associated with a first set of conditions associated with the communication of the signaling, where the control signaling indicates a model ID associated with the machine learning model, that the first set of conditions is associated with the machine learning model, or both.

In some examples, the data object manager 840 is capable of, configured to, or operable to support a means for storing a data object that associates the machine learning model with the model ID, the first set of conditions, or both, based on receiving the control signaling. In some examples, the control signaling manager 835 is capable of, configured to, or operable to support a means for receiving, from the second wireless device, additional control signaling indicating the model ID, the first set of conditions, or both. In some examples, the machine learning model manager 830 is capable of, configured to, or operable to support a means for performing one or more additional inferences using the machine learning model based on storing the data object and receiving the additional control signaling.

In some examples, the data object manager 840 is capable of, configured to, or operable to support a means for storing a data object that associates the machine learning model with the model ID, the first set of conditions, or both, based on receiving the control signaling. In some examples, the signaling manager 825 is capable of, configured to, or operable to support a means for identifying that the second wireless device is to communicate in accordance with the first set of conditions. In some examples, the machine learning model manager 830 is capable of, configured to, or operable to support a means for performing one or more additional inferences using the machine learning model based on storing the data object and identifying that the second wireless device is communicating in accordance with the first set of conditions.

In some examples, the capability signaling manager 845 is capable of, configured to, or operable to support a means for transmitting, to the second wireless device, capability signaling indicating a second set of conditions used by the first wireless device to communicate the signaling, where the one or more inferences are associated with the second set of conditions.

In some examples, the control signaling indicates that the machine learning model is applicable for communications associated with the second set of conditions.

In some examples, the second set of conditions include a quantity of communication layers supported at the first wireless device, a quantity of antennas at the first wireless device, or both.

In some examples, the signaling manager 825 is capable of, configured to, or operable to support a means for communicating additional signaling with the second wireless device, the additional wireless device, or both, in accordance with a set of additional conditions associated with the first wireless device. In some examples, the machine learning model manager 830 is capable of, configured to, or operable to support a means for performing, based on communicating the additional signaling in accordance with the set of additional conditions, one or more additional inferences using the machine learning model. In some examples, the signaling manager 825 is capable of, configured to, or operable to support a means for transmitting, to the second wireless device, a control message indicating that the machine learning model was applicable for performing the one or more additional inferences associated with the set of additional conditions.

In some examples, the control signaling manager 835 is capable of, configured to, or operable to support a means for receiving, from the second wireless device, additional control signaling indicating that the machine learning model is associated with the set of additional conditions. In some examples, the data object manager 840 is capable of, configured to, or operable to support a means for updating a data object associated with the machine learning model to include information associated with an association between the machine learning model and the set of additional conditions based on receiving the additional control signaling.

In some examples, the set of additional conditions include a speed of the first wireless device, a signal quality metric of wireless communications received by the first wireless device, network-based additional conditions, or any combination thereof.

In some examples, the first set of conditions include one or more network settings, an RRC configuration, or both.

In some examples, the one or more inferences include an inference associated with channel state feedback, an inference associated with one or more beams usable by the first wireless device, an inference associated with a geographical position of the first wireless device, or any combination thereof.

In some examples, the machine learning model includes a neural network model.

In some examples, the first wireless device is a UE and the second wireless device is a network entity. In some examples, the first wireless device is the network entity and the second wireless device is the UE.

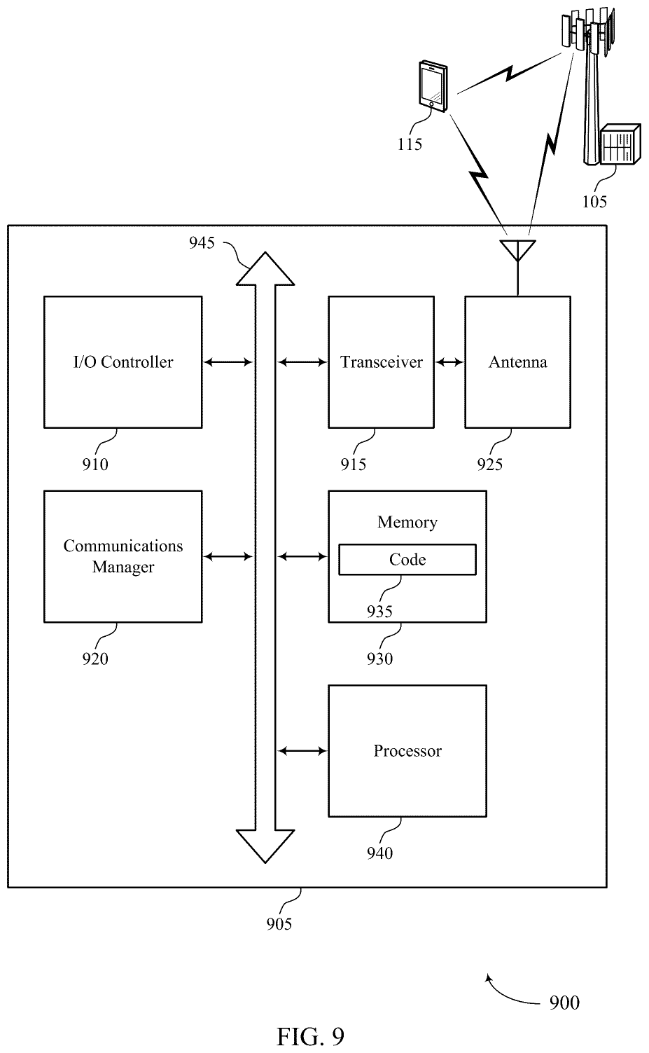

FIG. 9 shows a diagram of a system 900 including a device 905 that supports techniques for additional condition indication based on model monitoring in accordance with one or more aspects of the present disclosure. The device 905 may be an example of or include the components of a device 605, a device 705, a UE 115, or a network entity 105, as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for additional condition indication based on model monitoring). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for communicating signaling with a second wireless device, an additional wireless device, or both. The communications manager 920 is capable of, configured to, or operable to support a means for performing, based on the communication of the signaling, one or more inferences using a machine learning model. The communications manager 920 is capable of, configured to, or operable to support a means for transmitting, to the second wireless device, an indication that the machine learning model was applicable for performing the one or more inferences. The communications manager 920 is capable of, configured to, or operable to support a means for receiving, from the second wireless device, control signaling indicating that the machine learning model is applicable for communications that are associated with a first set of conditions associated with the communication of the signaling, where the control signaling indicates a model ID associated with the machine learning model, that the first set of conditions is associated with the machine learning model, or both.

By including or configuring the communications manager 920 in accordance with examples as described herein, the device 905 may support techniques for facilitating more efficient identification of machine learning models that may be used for performing inferences or predictions within a wireless communications system. By improving the ability of wireless devices to identify and define (e.g., assign a model ID) to machine learning models, techniques described herein may enable the wireless devices to distribute information associated with the identified model throughout the network, which may lead to more prevalent use of the model for making inferences or predictions, and therefore more efficient and reliable wireless communications. Moreover, techniques described herein may enable wireless devices to efficiently update previously trained machine learning models in order to apply the machine learning models to new sets of additional conditions for which the models were not originally trained. As such, aspects of the present disclosure may enable machine learning models to be extended to additional use-cases and scenarios (e.g., additional conditions), thereby increasing the use of the models and preventing the need for additional models to be trained for the additional conditions.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for additional condition indication based on model monitoring as described herein, or the at least one processor 940 and the at least one memory 930 may be otherwise configured to, individually or collectively, perform or support such operations.

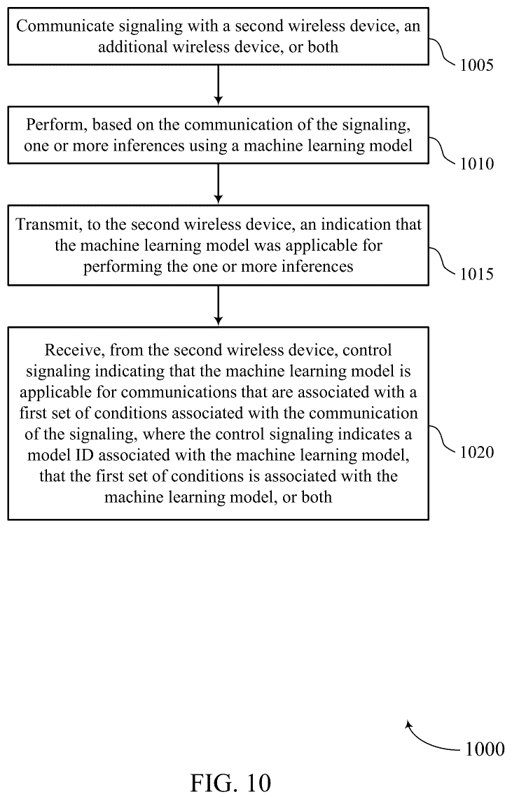

FIG. 10 shows a flowchart illustrating a method 1000 that supports techniques for additional condition indication based on model monitoring in accordance with aspects of the present disclosure. The operations of the method 1000 may be implemented by a UE or a network entity 105 as described herein. For example, the operations of the method 1000 may be performed by a UE 115 or a network entity 105 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include communicating signaling with a second wireless device, an additional wireless device, or both. The operations of block 1005 may be performed in accordance with examples as disclosed herein. In some examples, aspects of the operations of 1005 may be performed by a signaling manager 825 as described with reference to FIG. 8.

At 1010, the method may include performing, based on the communication of the signaling, one or more inferences using a machine learning model. The operations of block 1010 may be performed in accordance with examples as disclosed herein. In some examples, aspects of the operations of 1010 may be performed by a machine learning model manager 830 as described with reference to FIG. 8.

At 1015, the method may include transmitting, to the second wireless device, an indication that the machine learning model was applicable for performing the one or more inferences. The operations of block 1015 may be performed in accordance with examples as disclosed herein. In some examples, aspects of the operations of 1015 may be performed by a signaling manager 825 as described with reference to FIG. 8.

At 1020, the method may include receiving, from the second wireless device, control signaling indicating that the machine learning model is applicable for communications that are associated with a first set of conditions associated with the communication of the signaling, where the control signaling indicates a model ID associated with the machine learning model, that the first set of conditions is associated with the machine learning model, or both. The operations of block 1020 may be performed in accordance with examples as disclosed herein. In some examples, aspects of the operations of 1020 may be performed by a control signaling manager 835 as described with reference to FIG. 8.

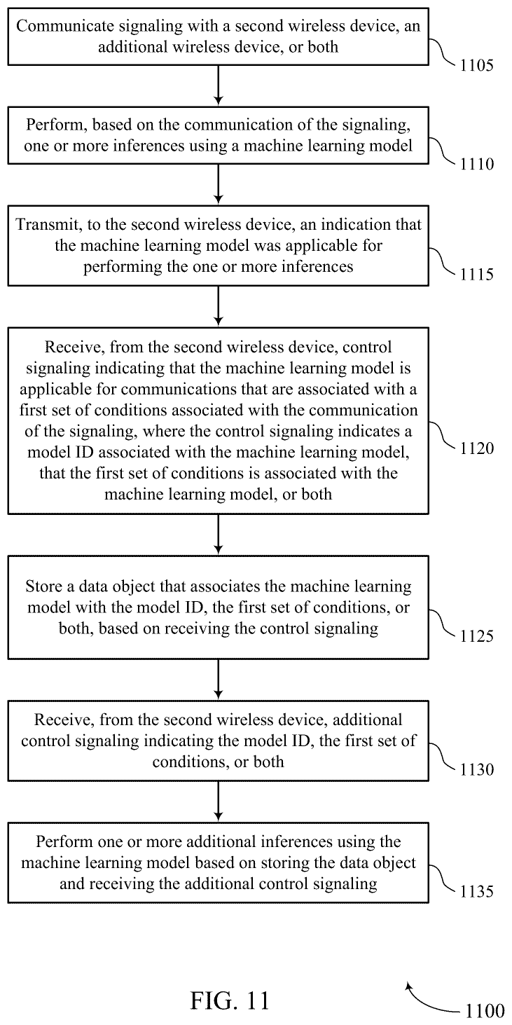

FIG. 11 shows a flowchart illustrating a method 1100 that supports techniques for additional condition indication based on model monitoring in accordance with aspects of the present disclosure. The operations of the method 1100 may be implemented by a UE or a network entity as described herein. For example, the operations of the method 1100 may be performed by a UE 115 or a network entity 105 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include communicating signaling with a second wireless device, an additional wireless device, or both. The operations of block 1105 may be performed in accordance with examples as disclosed herein. In some examples, aspects of the operations of 1105 may be performed by a signaling manager 825 as described with reference to FIG. 8.

At 1110, the method may include performing, based on the communication of the signaling, one or more inferences using a machine learning model. The operations of block 1110 may be performed in accordance with examples as disclosed herein. In some examples, aspects of the operations of 1110 may be performed by a machine learning model manager 830 as described with reference to FIG. 8.

At 1115, the method may include transmitting, to the second wireless device, an indication that the machine learning model was applicable for performing the one or more inferences. The operations of block 1115 may be performed in accordance with examples as disclosed herein. In some examples, aspects of the operations of 1115 may be performed by a signaling manager 825 as described with reference to FIG. 8.

At 1120, the method may include receiving, from the second wireless device, control signaling indicating that the machine learning model is applicable for communications that are associated with a first set of conditions associated with the communication of the signaling, where the control signaling indicates a model ID associated with the machine learning model, that the first set of conditions is associated with the machine learning model, or both. The operations of block 1120 may be performed in accordance with examples as disclosed herein. In some examples, aspects of the operations of 1120 may be performed by a control signaling manager 835 as described with reference to FIG. 8.

At 1125, the method may include storing a data object that associates the machine learning model with the model ID, the first set of conditions, or both, based on receiving the control signaling. The operations of block 1125 may be performed in accordance with examples as disclosed herein. In some examples, aspects of the operations of 1125 may be performed by a data object manager 840 as described with reference to FIG. 8.

At 1130, the method may include receiving, from the second wireless device, additional control signaling indicating the model ID, the first set of conditions, or both. The operations of block 1130 may be performed in accordance with examples as disclosed herein. In some examples, aspects of the operations of 1130 may be performed by a control signaling manager 835 as described with reference to FIG. 8.

At 1135, the method may include performing one or more additional inferences using the machine learning model based on storing the data object and receiving the additional control signaling. The operations of block 1135 may be performed in accordance with examples as disclosed herein. In some examples, aspects of the operations of 1135 may be performed by a machine learning model manager 830 as described with reference to FIG. 8.

The following provides an overview of aspects of the present disclosure:

Aspect 1: A method for wireless communications at a first wireless device, comprising: communicating signaling with a second wireless device, an additional wireless device, or both; performing, based at least in part on the communication of the signaling, one or more inferences using a machine learning model; transmitting, to the second wireless device, an indication that the machine learning model was applicable for performing the one or more inferences; and receiving, from the second wireless device, control signaling indicating that the machine learning model is applicable for communications that are associated with a first set of conditions associated with the communication of the signaling, wherein the control signaling indicates a model ID associated with the machine learning model, an indication that the first set of conditions is associated with the machine learning model, or both.

Aspect 2: The method of aspect 1, further comprising: storing a data object that associates the machine learning model with the model ID, the first set of conditions, or both, based at least in part on receiving the control signaling; receiving, from the second wireless device, additional control signaling indicating the model ID, the first set of conditions, or both; and performing one or more additional inferences using the machine learning model based at least in part on storing the data object and receiving the additional control signaling.

Aspect 3: The method of any of aspects 1 through 2, further comprising: storing a data object that associates the machine learning model with the model ID, the first set of conditions, or both, based at least in part on receiving the control signaling; identifying that the second wireless device is to communicate in accordance with the first set of conditions; and performing one or more additional inferences using the machine learning model based at least in part on storing the data object and identifying that the second wireless device is communicating in accordance with the first set of conditions.

Aspect 4: The method of any of aspects 1 through 3, further comprising: transmitting, to the second wireless device, capability signaling indicating a second set of conditions used by the first wireless device to communicate the signaling, wherein the one or more inferences are associated with the second set of conditions.

Aspect 5: The method of aspect 4, wherein the control signaling indicates that the machine learning model is applicable for communications associated with the second set of conditions.

Aspect 6: The method of any of aspects 4 through 5, wherein the second set of conditions comprise a quantity of communication layers supported at the first wireless device, a quantity of antennas at the first wireless device, or both.

Aspect 7: The method of any of aspects 1 through 6, further comprising: communicating additional signaling with the second wireless device, the additional wireless device, or both, in accordance with a set of additional conditions associated with the second wireless device; performing, based at least in part on communicating the additional signaling in accordance with the set of additional conditions, one or more additional inferences using the machine learning model; and transmitting, to the second wireless device, a control message indicating that the machine learning model was applicable for performing the one or more additional inferences associated with the set of additional conditions.

Aspect 8: The method of aspect 7, further comprising: receiving, from the second wireless device, additional control signaling indicating that the machine learning model is associated with the set of additional conditions; and updating a data object associated with the machine learning model to include information associated with an association between the machine learning model and the set of additional conditions based at least in part on receiving the additional control signaling.

Aspect 9: The method of any of aspects 7 through 8, wherein the set of additional conditions comprise a speed of the first wireless device, a signal quality metric of wireless communications received by the first wireless device, network-based additional conditions, or any combination thereof.

Aspect 10: The method of any of aspects 1 through 9, wherein the first set of conditions comprise one or more network settings, an RRC configuration, or both.

Aspect 11: The method of any of aspects 1 through 10, wherein the one or more inferences comprise an inference associated with channel state feedback, an inference associated with one or more beams usable by the first wireless device, an inference associated with a geographical position of the first wireless device, or any combination thereof.

Aspect 12: The method of any of aspects 1 through 11, wherein the machine learning model comprises a neural network model.

Aspect 13: The method of any of aspects 1 through 12, wherein the first wireless device comprises a UE and the second wireless device comprises a network entity, or the first wireless device comprises the network entity and the second wireless device comprises the UE.

Aspect 14: The method of any of aspects 1 through 13, further comprising: monitoring a performance of the machine learning model based at least in part on performing the one or more inferences; and determining that the machine learning model is applicable for performing the one or more inferences based at least in part on monitoring the performance of the machine learning model.

Aspect 15: A method for wireless communications at a first wireless device, comprising: communicating signaling with a second wireless device, an additional wireless device, or both; performing, based at least in part on the communication of the signaling, one or more inferences using a functionality; transmitting, to the second wireless device, an indication that the functionality was applicable for performing the one or more inferences; and receiving, from the second wireless device, control signaling indicating that the functionality is applicable for communications that are associated with a first set of conditions associated with the communication of the signaling, wherein the control signaling indicates a functionality identifier associated with the functionality, an indication that the first set of conditions is associated with the functionality, or both.

Aspect 16: The method of aspect 15, further comprising: storing a data object that associates the functionality with the functionality identifier, the first set of conditions, or both, based at least in part on receiving the control signaling; receiving, from the second wireless device, additional control signaling indicating the functionality identifier, the first set of conditions, or both; and performing one or more additional inferences using the functionality based at least in part on storing the data object and receiving the additional control signaling.

Aspect 17: The method of any of aspects 15 through 16, further comprising: storing a data object that associates the functionality with the functionality identifier, the first set of conditions, or both, based at least in part on receiving the control signaling; identifying that the second wireless device is to communicate in accordance with the first set of conditions; and performing one or more additional inferences using the functionality based at least in part on storing the data object and identifying that the second wireless device is communicating in accordance with the first set of conditions.

Aspect 18: The method of any of aspects 15 through 17, further comprising: transmitting, to the second wireless device, capability signaling indicating a second set of conditions used by the first wireless device to communicate the signaling, wherein the one or more inferences are associated with the second set of conditions.

Aspect 19: The method of aspect 18, wherein the control signaling indicates that the functionality is applicable for communications associated with the second set of conditions.

Aspect 20: The method of any of aspects 18 through 19, wherein the second set of conditions comprise a quantity of communication layers supported at the first wireless device, a quantity of antennas at the first wireless device, or both.

Aspect 21: The method of any of aspects 15 through 20, further comprising: communicating additional signaling with the second wireless device, the additional wireless device, or both, in accordance with a set of additional conditions associated with the second wireless device; performing, based at least in part on communicating the additional signaling in accordance with the set of additional conditions, one or more additional inferences using the functionality; and transmitting, to the second wireless device, a control message indicating that the functionality was applicable for performing the one or more additional inferences associated with the set of additional conditions.

Aspect 22: The method of aspect 21, further comprising: receiving, from the second wireless device, additional control signaling indicating that the functionality is associated with the set of additional conditions; and updating a data object associated with the functionality to include information associated with an association between the functionality and the set of additional conditions based at least in part on receiving the additional control signaling.

Aspect 23: The method of any of aspects 21 through 22, wherein the set of additional conditions comprise a speed of the first wireless device, a signal quality metric of wireless communications received by the first wireless device, network-based additional conditions, or any combination thereof.

Aspect 24: The method of any of aspects 15 through 23, wherein the first set of conditions comprise one or more network settings, a radio resource control configuration, or both.

Aspect 25: The method of any of aspects 15 through 24, wherein the one or more inferences comprise an inference associated with channel state feedback, an inference associated with one or more beams usable by the first wireless device, an inference associated with a geographical position of the first wireless device, or any combination thereof.

Aspect 26: The method of any of aspects 15 through 25, wherein the functionality is associated with one or more machine learning models executable by the first wireless device, the second wireless device, or both.

Aspect 27: The method of any of aspects 15 through 26, wherein the first wireless device comprises a UE and the second wireless device comprises a network entity, or the first wireless device comprises the network entity and the second wireless device comprises the UE.

Aspect 28: The method of any of aspects 15 through 27, further comprising: monitoring a performance of the functionality based at least in part on performing the one or more inferences; and determining that the functionality is applicable for performing the one or more inferences based at least in part on monitoring the performance of the functionality.

Aspect 29: A first wireless device comprising one or more memories storing processor-executable code, and one or more processors coupled with the one or more memories and individually or collectively operable to execute the code to cause the first wireless device to perform a method of any of aspects 1 through 14.

Aspect 30: A first wireless device comprising at least one means for performing a method of any of aspects 1 through 14.

Aspect 31: A non-transitory computer-readable medium storing code the code comprising instructions executable by a processor to perform a method of any of aspects 1 through 14.

Aspect 32: A first wireless device comprising one or more memories storing processor-executable code, and one or more processors coupled with the one or more memories and individually or collectively operable to execute the code to cause the first wireless device to perform a method of aspects 15 through 28.

Aspect 33: A first wireless device comprising at least one means for performing a method of any of aspects 15 through 28.

Aspect 34: A non-transitory computer-readable medium storing code the code comprising instructions executable by a processor to perform a method of any of aspects 15 through 28.

In some cases, one or more features of Aspects 15 through 28 may be combined with one or more features of any of Aspects 1 through 14. For example, techniques or other teachings herein related to machine learning models (e.g., related to identifying or updating machine learning models) may additionally or alternatively be applied to functionalities (e.g., related to identifying or updating functionalities), and vice versa.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of two or more items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

Also, as used herein, the phrase “a set” shall be construed as including the possibility of a set with one member. That is, the phrase “a set” shall be construed in the same manner as “one or more.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
communicate signaling with a second wireless device, an additional wireless device, or both;
perform, based at least in part on the communication of the signaling, one or more inferences using a machine learning model;
transmit, to the second wireless device, an indication that the machine learning model was applicable for performing the one or more inferences; and
receive, from the second wireless device, control signaling indicating that the machine learning model is applicable for communications that are associated with a first set of conditions associated with the communication of the signaling, wherein the control signaling indicates a model identifier associated with the machine learning model, that the first set of conditions is associated with the machine learning model, or both.

2. The first wireless device of claim 1, wherein the one or more processors are individually or collectively further operable to execute the code to cause the first wireless device to:
store a data object that associates the machine learning model with the model identifier, the first set of conditions, or both, based at least in part on receiving the control signaling;
receive, from the second wireless device, additional control signaling indicating the model identifier, the first set of conditions, or both; and
perform one or more additional inferences using the machine learning model based at least in part on storing the data object and receiving the additional control signaling.

3. The first wireless device of claim 1, wherein the one or more processors are individually or collectively further operable to execute the code to cause the first wireless device to:
store a data object that associates the machine learning model with the model identifier, the first set of conditions, or both, based at least in part on receiving the control signaling;
identify that the second wireless device is to communicate in accordance with the first set of conditions; and
perform one or more additional inferences using the machine learning model based at least in part on storing the data object and identifying that the second wireless device is communicating in accordance with the first set of conditions.

4. The first wireless device of claim 1, wherein the one or more processors are individually or collectively further operable to execute the code to cause the first wireless device to:
transmit, to the second wireless device, capability signaling indicating a second set of conditions used by the first wireless device to communicate the signaling, wherein the one or more inferences are associated with the second set of conditions.

5. The first wireless device of claim 4, wherein the control signaling indicates that the machine learning model is applicable for communications associated with the second set of conditions.

6. The first wireless device of claim 4, wherein the second set of conditions comprise a quantity of communication layers supported at the first wireless device, a quantity of antennas at the first wireless device, or both.

7. The first wireless device of claim 1, wherein the one or more processors are individually or collectively further operable to execute the code to cause the first wireless device to:
communicate additional signaling with the second wireless device, the additional wireless device, or both, in accordance with a set of additional conditions associated with the second wireless device;
perform, based at least in part on communicating the additional signaling in accordance with the set of additional conditions, one or more additional inferences using the machine learning model; and
transmit, to the second wireless device, a control message indicating that the machine learning model was applicable for performing the one or more additional inferences associated with the set of additional conditions.

8. The first wireless device of claim 7, wherein the one or more processors are individually or collectively further operable to execute the code to cause the first wireless device to:
receive, from the second wireless device, additional control signaling indicating that the machine learning model is associated with the set of additional conditions; and
update a data object associated with the machine learning model to include information associated with an association between the machine learning model and the set of additional conditions based at least in part on receiving the additional control signaling.

9. The first wireless device of claim 7, wherein the set of additional conditions comprise a speed of the first wireless device, a signal quality metric of wireless communications received by the first wireless device, network-based additional conditions, or any combination thereof.

10. The first wireless device of claim 1, wherein the first set of conditions comprise one or more network settings, a radio resource control configuration, or both.

11. The first wireless device of claim 1, wherein the one or more inferences comprise an inference associated with channel state feedback, an inference associated with one or more beams usable by the first wireless device, an inference associated with a geographical position of the first wireless device, or any combination thereof.

12. The first wireless device of claim 1, wherein the machine learning model comprises a neural network model.

13. The first wireless device of claim 1,
wherein the first wireless device comprises a user equipment (UE) and the second wireless device comprises a network entity, or
wherein the first wireless device comprises the network entity and the second wireless device comprises the UE.

14. The first wireless device of claim 1, wherein the one or more processors are individually or collectively further operable to execute the code to cause the first wireless device to:
monitor a performance of the machine learning model based at least in part on performing the one or more inferences; and
determine that the machine learning model is applicable for performing the one or more inferences based at least in part on monitoring the performance of the machine learning model.

15. A method for wireless communications at a first wireless device, comprising:
communicating signaling with a second wireless device, an additional wireless device, or both;
performing, based at least in part on the communication of the signaling, one or more inferences using a machine learning model;
transmitting, to the second wireless device, an indication that the machine learning model was applicable for performing the one or more inferences; and
receiving, from the second wireless device, control signaling indicating that the machine learning model is applicable for communications that are associated with a first set of conditions associated with the communication of the signaling, wherein the control signaling indicates a model identifier associated with the machine learning model, that the first set of conditions is associated with the machine learning model, or both.

16. The method of claim 15, further comprising:
storing a data object that associates the machine learning model with the model identifier, the first set of conditions, or both, based at least in part on receiving the control signaling;
receiving, from the second wireless device, additional control signaling indicating the model identifier, the first set of conditions, or both; and
performing one or more additional inferences using the machine learning model based at least in part on storing the data object and receiving the additional control signaling.

17. The method of claim 15, further comprising:
storing a data object that associates the machine learning model with the model identifier, the first set of conditions, or both, based at least in part on receiving the control signaling;
identifying that the second wireless device is to communicate in accordance with the first set of conditions; and
performing one or more additional inferences using the machine learning model based at least in part on storing the data object and identifying that the second wireless device is communicating in accordance with the first set of conditions.

18. The method of claim 15, further comprising:
transmitting, to the second wireless device, capability signaling indicating a second set of conditions used by the first wireless device to communicate the signaling, wherein the one or more inferences are associated with the second set of conditions.

19. The method of claim 15, further comprising:
communicating additional signaling with the second wireless device, the additional wireless device, or both, in accordance with a set of additional conditions associated with the second wireless device;
performing, based at least in part on communicating the additional signaling in accordance with the set of additional conditions, one or more additional inferences using the machine learning model; and
transmitting, to the second wireless device, a control message indicating that the machine learning model was applicable for performing the one or more additional inferences associated with the set of additional conditions.

20. A non-transitory computer-readable medium storing code, the code comprising instructions executable by one or more processors to:
communicate signaling with a second wireless device, an additional wireless device, or both;
perform, based at least in part on the communication of the signaling, one or more inferences using a machine learning model;
transmit, to the second wireless device, an indication that the machine learning model was applicable for performing the one or more inferences; and
receive, from the second wireless device, control signaling indicating that the machine learning model is applicable for communications that are associated with a first set of conditions associated with the communication of the signaling, wherein the control signaling indicates a model identifier associated with the machine learning model, that the first set of conditions is associated with the machine learning model, or both.
